(19) United States
(12) Patent Application Publication
(10) Pub. No.: US 2010/0211990 A1
(43) Pub. Date: Aug. 19, 2010

(54) Packet Detection Method for Wireless Communication Device and Related Device

(76) Inventor: Wen-Sheng Hou, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/485,034

(22) Filed: Jun. 15, 2009

(30) Foreign Application Priority Data
Feb. 17, 2009 (TW) 098104951

(51) Int. Cl. H04L 9/32

(52) U.S. Cl. 726/2

(57) ABSTRACT

A packet detection method for a wireless communication device includes receiving a wireless communication signal and demodulating the wireless communication signal into a packet signal; comparing the packet signal according to an access code to generate a comparison result; estimating energy distribution of the packet signal to generate an estimation result; and determining whether the packet signal belongs to the wireless communication device according to the comparison result and the estimation result.

### BACKGROUND OF THE INVENTION

1. Field of the Invention

The present invention relates to a packet detection method and related device for a wireless communications device, and more particularly, to a packet detection method and related device capable of identifying the accuracy of a packet.

2. Description of the Prior Art

Bluetooth is a short distance wireless technology which serves as a bridge among dissimilar fixed (or mobile) devices for establishing a wireless connection to transmit data and voice. Also, Bluetooth has several advantages, including low-power, low-cost, small size, light weight, and is used more and more frequently in daily life.

Please refer to FIG. 1. FIG. 1 is a schematic diagram of a common Bluetooth packet format 10 in the prior art. As shown in FIG. 1, the common Bluetooth packet format 10 includes an access code 102, a header 104, and a data packet 106. The access code 102 is utilized for identifying packet. The header 104 is used for illustrating type and length of data. The data packet 106 is the transmitted data and/or voice content. Generally speaking, every packet has different binary access codes with various users or purposes. Therefore, for receiving packets accurately, a Bluetooth device can implement a detection process for checking whether the access code of the packet is referable to the Bluetooth device after receiving a packet in order to decide whether to take the packet for a following process or to discard the packet.

In version 2.0+ of the Bluetooth specification with Enhanced Data Rate (EDR), the access code 102 and the header 104 use the Gaussian Frequency Shift Keying (GFSK) modulation technique, and the data packet 106 uses the Differential Phase Shift Keying (DPSK) modulation technique. However, as is well known by those skilled in the art, there is often channel distortion for the receiving end caused by noise and multipath interference, resulting in a mis-estimate of the access code. For example, when an access code is short, a noise signal which has similar signal peak with the access code may be mistaken as an actual packet to produce false alarm, reducing the packet detection accuracy.

In addition, a carrier frequency offset often occurs due to a local oscillator frequency mis-match between transmitter and receiver, or the Doppler Effect while using carrier-based modulation, so as to affect the receiving performance. Generally, in a Bluetooth wireless communication system, the GFSK modulated wireless communication signal S_{IN} can be demodulated into a binary phase shift keying (BPSK) packet signal S_{P}, and the effect of carry frequency offset is also simultaneously converted to a DC offset after demodulation. Therefore, the receiver may determine an inaccurate access code due to DC offset, which results in packet loss. Consequently, there is a requirement to provide a more accurate packet detection method to improve the data transmission performance.

### SUMMARY OF THE INVENTION

It is therefore a primary objective of the claimed invention to provide a packet detection method and related device for a wireless communications device.

The present invention discloses a packet detection method for a wireless communication device, comprising: receiving a wireless communication signal and demodulating the wireless communication signal into a packet signal; comparing the packet signal according to an access code to generate a comparison result; estimating energy distribution of the packet signal to generate an estimation result; and determining whether the packet signal belongs to the wireless communication device according to the comparison result and the estimation result.

The present invention further discloses a wireless communication device, wherein the wireless communication device receives a wireless communication signal and demodulates the wireless communication signal into a packet signal, the wireless communication device comprising: an access code comparison unit for comparing the packet signal according to an access code to generate a comparison result; an estimation unit for estimating energy distribution of the packet signal to generate an estimation result; and a determination unit coupled to the access code comparison unit and the estimation unit for determining whether the packet signal belongs to the wireless communication device according to the comparison result and the estimation result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a common Bluetooth packet format in the prior art.

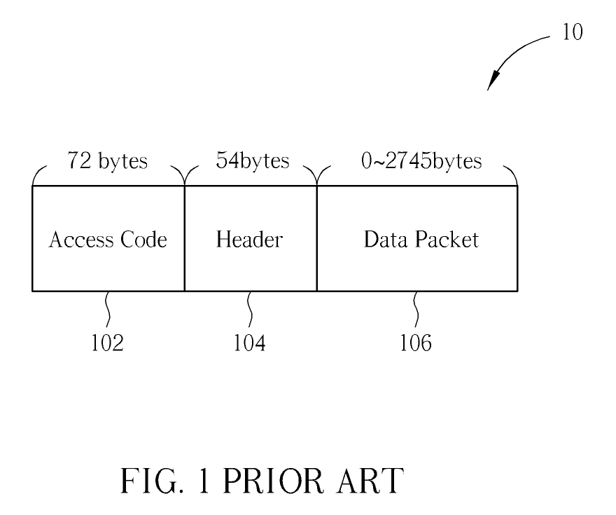

FIG. 2 is a schematic diagram of a wireless communication device according to an embodiment of the present invention.

FIG. 3 is a schematic diagram of the access code comparison unit shown in FIG. 2 according to an embodiment of the present invention.

FIG. 4 is a schematic diagram of the estimation unit shown in FIG. 2 according to an embodiment of the present invention.

FIG. 5 is a schematic diagram of the energy estimation unit shown in FIG. 4 according to an embodiment of the present invention.

FIG. 6 is a procedure according to an embodiment of the invention.

### DETAILED DESCRIPTION

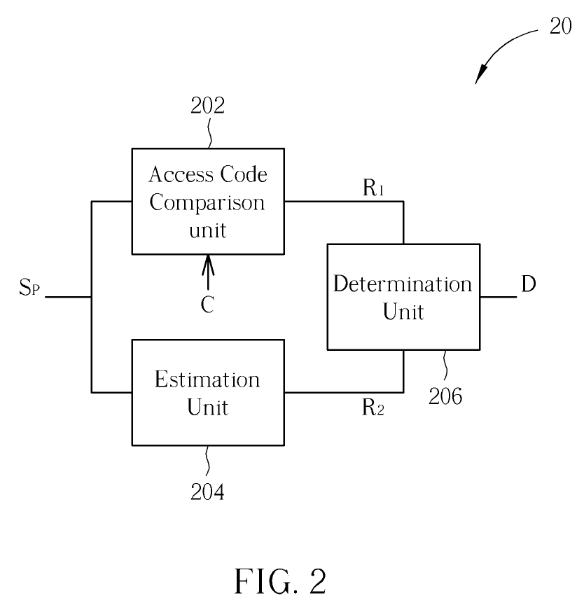

Please refer to FIG. 2. FIG. 2 is a schematic diagram of a packet detection device 20 according to an embodiment of the present invention. The packet detection device 20 is utilized for a wireless communication device. Preferably, the wireless communication device is a Bluetooth communication device, but this should not be a limitation of the present invention. In the embodiment, the wireless communication device receives a wireless communication signal S_{IN}, and demodulates the wireless communication signal S_{IN} into a packet signal S_{P} for implementing a detection process. The packet detection device 20 includes an access code comparison unit 202, an estimation unit 204 and a determination unit 206. The access code comparison unit 202 is utilized for comparing the packet signal S_{P} with an access code C to generate a comparison result R₁. The estimation unit 204 is utilized for estimating energy distribution of the packet signal S_{P} to generate an estimation result R₂. The determination unit 206 is coupled to access code comparison unit 202 and estimation unit 204 for determining whether the packet signal S_{P} belongs to the wireless communication device according to comparison result R₁ and the estimation result R₂, to generate a determination result D.

In brief, the present invention can examine whether the information in packet signal S_{P} is the same as the access code C by the access code comparison unit 202. If the packet signal S_{P} is identical to the access code C, it represents the packet signal S_{P} belongs to the wireless communication device and can be accessed by the wireless communication device. Therefore, the comparison result R₁ of the access code comparison unit 202 is: conformity with the access code or inconformity with the access code. In other words, the packet detection device 20 can decide whether to preserve the packet signal through comparing the packet signal S_{P} with the access code C corresponding to the wireless communication device. Furthermore, the estimation unit 204 further estimates energy distribution of the packet signal S_{P} to determine whether the packet signal S_{P} has energy beyond the possible distribution frequency bands. In this way, when the packet signal S_{P} has energy beyond the possible distribution frequency bands, the packet signal S_{P} may not be an access code signal or the packet signal S_{P} is affected by the channel noise. Therefore, the estimation result R₂ of the estimation unit 204 can indicate: no energy beyond the bands or energy beyond the bands. Finally, the determination unit 206 of the packet detection device 20 determines whether the packet signal S_{P} belongs to the wireless communication device according to comparison result R₁ and the estimation result R₂. When the comparison result R₁ indicates conformity with the access code and the estimation result R₂ indicates no energy beyond the bands, the determination unit 206 generates a determination result D to show the packet signal S_{P} belongs to the wireless communication device. As a result, the packet detection device 20 can identify the accuracy of the packet signal through above double examination.

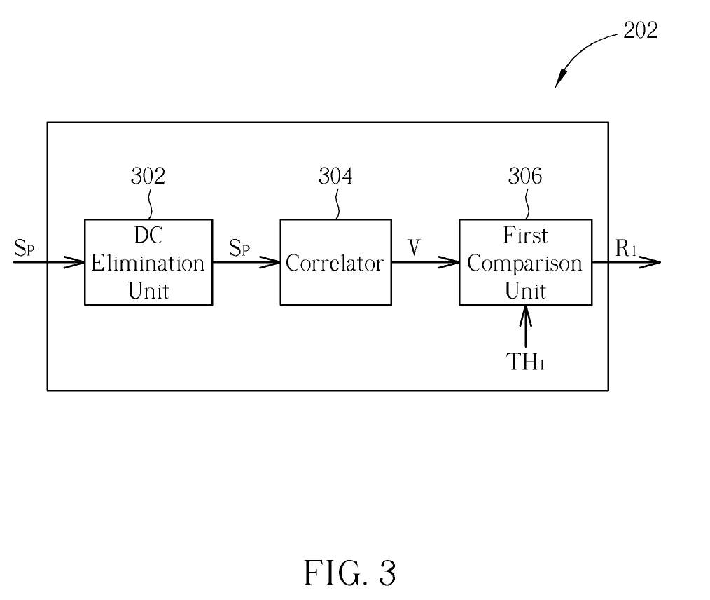

Further description associated with the operation of the access code comparison unit 202 is now presented in conjunction with FIG. 3. FIG. 3 is a schematic diagram of the access code comparison unit 202 shown in FIG. 2 according to an embodiment of the present invention. The access code comparison unit 202 includes a DC elimination unit 302, a correlator 304, and a first comparison unit 306. The DC elimination unit 302 is utilized for eliminating DC components of the packet signal S_{P}. The correlator 304 is coupled to the DC elimination unit 302 for calculating the correlation between the packet signal S_{P} and the access code C according to the access code C to generate a correction value V. The first comparison unit 306 is coupled to the correlator 304 for determining the comparison result R₁ according to a first threshold value TH₁ and the correction value V. In general, the GFSK modulated wireless communication signal S_{IN} can be demodulated into a BPSK packet signal S_{P} through a demodulator, such as a discriminator. Meanwhile, the effect of carry frequency offset at the wireless communication signal S_{IN} is also converted to a DC offset after being demodulated into the packet signal S_{P}. In such a condition, the access code comparison unit 202 can eliminate the DC component of the packet signal S_{P} by using the DC elimination unit 302 for resolving the carry frequency offset issue. After that, the packet signal S_{P,} having eliminated the DC component, is transmitted to the correlator 304. The correlator 304 is able to calculate the correlation between the packet signal S_{P} and the access code C, and generate a correction value V. So, if the packet signal S_{P} is the same as (or quite similar to) the access code C, the correlator 304 generates a larger correction value V. On the contrary, the correlator 304 generates a smaller correction value when the packet signal S_{P} is not the same as (or not quite similar to) the access code C. Furthermore, the first comparison unit 306 determines the comparison result R₁ according to the correction value V and a first threshold value TH₁. When the correction value V is greater than or equal to the first threshold value TH₁, it represents the packet signal S_{P} is similar to the access code C, so that the comparison result R₁ indicates conformity with the access code. On the contrary, when the correction value V is smaller than the first threshold value TH₁, it represents the packet signal S_{P} is un-correlative to the access code C, so that the comparison result R₁ indicates inconformity with the access code.

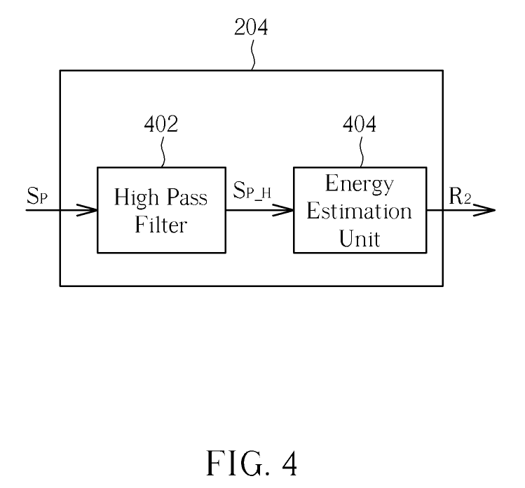

The following further elaborates the operation of the estimation unit 204. Please refer to FIG. 4. FIG. 4 is a schematic diagram of the estimation unit 204 shown in FIG. 2 according to an embodiment of the present invention. The estimation unit 204 is utilized for estimating energy distribution of packet signal S_{P} to generate an estimation result R₂ for determining accuracy of packet signal S_{P}. As shown in FIG. 4, the estimation unit 204 includes high pass filter 402, and an energy estimation unit 404. The high pass filter 402 is utilized for extracting high frequency components S_{P}_{_{—}}_{H} of the packet signal S_{P}. The energy estimation unit 404 is coupled to high pass filter 402 for estimating energy of the packet signal S_{P} to generate estimation result R₂. For example, in a Bluetooth communication system, a packet signal with an access code usually uses GFSK modulation. Suppose a discriminator uses difference of input signal and the output value of the discriminator is among −π and +π. Therefore, when a GFSK signal is demodulated into a BPSK signal through the discriminator, the demodulated BPSK signal often distributes over low frequency range, that is the demodulated BPSK signal has less energy over the high frequency range. But, if a pure noise signal is demodulated through the discriminator, the demodulated noise signal may distribute over both high and low frequency ranges. As a result, the high pass filter 402 can be utilized for filtering actual packet signal of the packet signal S_{P} over the low frequency range. Again, if the energy estimation unit 404 estimates energy existing over high frequency bands, it represents the packet signal S_{P} is interfered with noise or the packet signal S_{P} is not a GFSK modulated signal, i.e. the packet signal S_{P} is not a access code signal. In short, the estimation unit 204 can estimate energy distribution of the packet signal S_{P} to determine whether the packet signal S_{P} has energy beyond the possible distribution frequency bands and the packet signal S_{P} is a noise signal or a signal unrelated to the wireless communication device. In such a condition, although the comparison result R₁ of access code comparison unit 202 indicates conformity, the packet signal S_{P} is a noise signal. The estimation unit 204 can be performed as a second examination to reduce the false alarm problem.

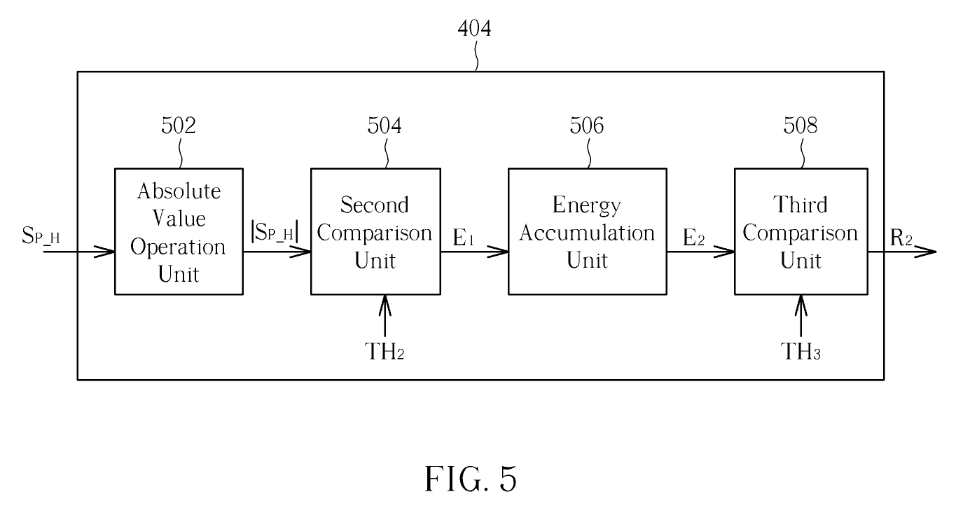

Further to illustrate the energy estimation unit 404, please refer to FIG. 5. FIG. 5 is a schematic diagram of the energy estimation unit 404 shown in FIG. 4 according to an embodiment of the present invention. As shown in FIG. 5, the energy estimation unit 404 includes an operation unit, such as an absolute value operation unit 502, a second comparison unit 504, an energy accumulation unit 506, and a third comparison unit 508. The absolute value operation unit 502 is coupled to the high pass filter 402 for performing an absolute operation with the filtered packet signal S_{P}_{_{—}}_{H} to obtain an amplitude value |S_{P}_{_{—}}_{H}| of the packet signal S_{P}_{_{—}}_{H}. The second comparison unit 504 is coupled to the absolute value operation unit 502 for generating an energy comparison result E₁ according to a second threshold value TH₂ and the amplitude value |S_{P}_{_{—}}_{H}|. Preferably, the second comparison unit 504 can compare transient energy of packet signal S_{P}_{_{—}}_{H} during each specific time interval with the second threshold value TH₂, which the transient energy can be amplitude value |S_{P}_{_{—}}_{H}| of the packet signal S_{P}_{_{—}}_{H} during each specific time interval. In such a condition, if the transient energy (amplitude value |S_{P}_{_{—}}_{H}| of the packet signal S_{P}_{_{—}}_{H}) is greater the second threshold value TH₂, it means the packet signal S_{P}_{_{—}}_{H} exhibits energy over the high frequency ranges, so that the energy comparison result E₁ is determined as 1. On the contrary, when the transient energy (amplitude value |S_{P}_{_{—}}_{H}| of the packet signal S_{P}_{_{—}}_{H}) is not greater the second threshold value TH₂, the energy comparison result E₁ is determined as 0. Moreover, the energy accumulation unit 506 is coupled to the second comparison unit 504 for generating an accumulated value E₂ through accumulating all of the energy comparison results E₁. Finally, the third comparison unit 508 coupled to the energy accumulation unit 506 is utilized for generating an estimation result R₂ by comparing the accumulated value E₂ with a third threshold value TH₃. When the accumulated value E₂ is greater than or equal to the third threshold value TH₃, the estimation result R₂ indicates energy beyond the bands. Otherwise, when the accumulated value E₂ is smaller than the third threshold value TH₃, the estimation result R₂ indicates no energy beyond the bands. In other words, if the accumulated value E₂ is smaller than the third threshold value TH₃, it means there is less energy (under an allowance range) existing over the high frequency range. When the accumulated value E₂ is greater than or equal to the third threshold value TH₃, it means the wireless communication signal S_{IN} should be a noise or other type signal, but is not a GFSK modulated signal or a access code signal.

Therefore, the packet detection device 20 can remove the DC portion of packet signal for reducing effect of the carrier frequency offset, and estimate whether energy exists beyond possible frequency bands in order to determine the actual GFSK modulated access code signal. In other words, the present invention can identify the accuracy of the packet signal through the above double check approach, not only dealing with the effect of the carrier frequency offset, but reducing the false alarm, enhancing the capability of packet detection.

Note that, the packet detection device 20 is an exemplary embodiment of the present invention, and those skilled in the art can make alternations and modifications accordingly. For example, the above-mentioned packet signal or access code can be applied in any amount or code length for the wireless communication device. Preferably, the wireless communication signal is a GFSK signal, and the corresponding demodulated packet signal is a BPSK signal. In addition, the DC elimination unit 302 can be any device which can eliminate the DC component of signal, such as a high pass filter.

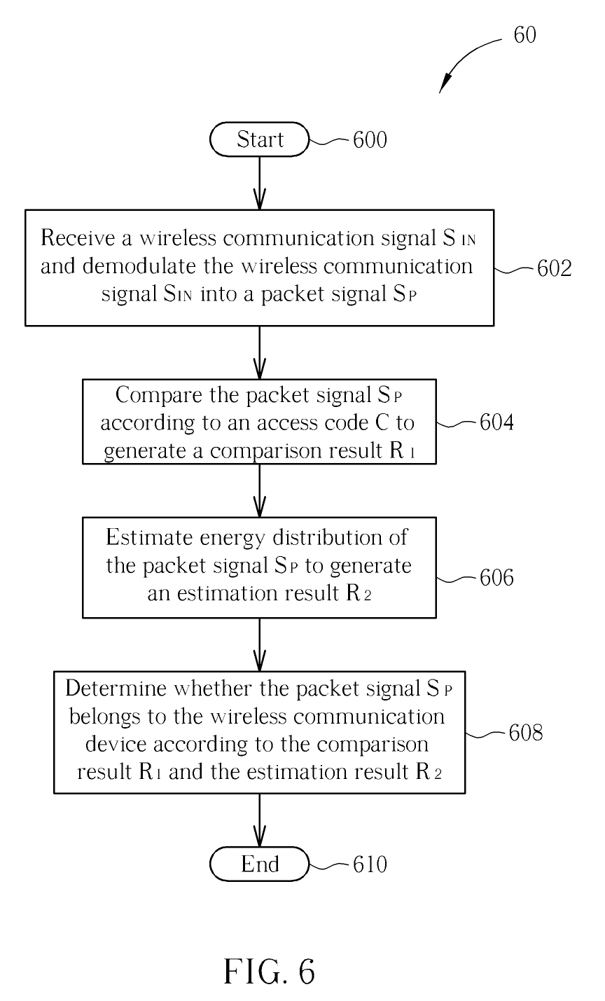

As to the implementation of the packet detection device 20, please refer to FIG. 6. FIG. 6 is a procedure 60 according to an embodiment of the invention. The procedure 60 is utilized for estimating the accuracy of the received packet for a wireless communication device. The procedure 60 comprises the following steps:

Step 600: Start.

Step 602: Receive a wireless communication signal S_{IN} and demodulate the wireless communication signal S_{IN} into a packet signal S_{P} by the wireless communication device.

Step 604: Compare the packet signal S_{P} according to an access code C to generate a comparison result R₁.

Step 606: Estimate energy distribution of the packet signal S_{P} to generate an estimation result R₂.

Step 608: Determine whether the packet signal S_{P} belongs to the wireless communication device according to the comparison result R₁ and the estimation result R₂.

Step 610: End.

Please note that the procedure 60 is utilized for illustrating the implementation of the packet detection device 20, and the related variations and the detailed description can be referred to in the foregoing description, so as not to be narrated herein for the sake of brevity.

In summary, the present invention can eliminate the DC portion of packet signal for reducing effect of the carrier frequency offset, and estimate whether energy exists beyond expected frequency bands in order to determine the actual GFSK modulated access code signal. In other words, the present invention can identify the accuracy of the packet signal through a double check approach, not only dealing with the effect of the carrier frequency offset, but reducing the false alarm, enhancing the capability of packet detection.

Those skilled in the art will readily observe that numerous modifications and alterations of the device and method may be made while retaining the teachings of the invention.

What is claimed is:

1. A packet detection method for a wireless communication device, comprising:
receiving a wireless communication signal and demodulating the wireless communication signal into a packet signal;
comparing the packet signal according to an access code to generate a comparison result;
estimating energy distribution of the packet signal to generate an estimation result; and
determining whether the packet signal belongs to the wireless communication device according to the comparison result and the estimation result.

2. The method of claim 1, wherein the step of comparing the packet signal according to the access code to generate the comparison result comprises:
eliminating a DC component of the packet signal;
calculating a correlation between the packet signal and the access code according to the access code to generate a correction value; and
determining the comparison result according to a first threshold value and the correction value.

3. The method of claim 1, wherein the step of estimating energy distribution of the packet signal to generate the estimation result comprises:
extracting a high frequency component of the packet signal; and
estimating an energy of the packet signal to generate the estimation result.

4. The method of claim 3, wherein the step of estimating an energy of the packet signal to generate the estimation result comprises:
obtaining an amplitude of the packet signal;
generating an energy comparison result according to a second threshold value and the amplitude of the packet signal;
generating an accumulated value according to the energy comparison result ; and
generating the estimation result according to a third threshold value and the accumulated value.

5. The method of claim 1, wherein the step of determining whether the packet signal belongs to the wireless communication device according to the comparison result and the estimation result determines the packet signal belongs to the wireless communication device when the comparison result indicates conformity with the access code and the estimation result indicates substantially no energy beyond expected frequency bands.

6. The method of claim 1, wherein the access code corresponds to the wireless communication device.

7. The method of claim 1, wherein the wireless communication signal is a Gaussian Frequency Shift Keying (GFSK) signal, and the packet signal is a Binary Phase Shift Keying (BPSK) signal.

8. The method of claim 1, wherein the wireless communication device is a Bluetooth wireless communication device.

9. A wireless communication device, for receiving a wireless communication signal and demodulates the wireless communication signal into a packet signal, the packet detection device comprising:
an access code comparison unit for comparing the packet signal according to an access code to generate a comparison result;
an estimation unit for estimating energy a distribution of the packet signal to generate an estimation result; and
a determination unit coupled to the access code comparison unit and the estimation unit for determining whether the packet signal belongs to the wireless communication device according to the comparison result and the estimation result.

10. The wireless communication device of claim 9, wherein the access code comparison unit comprises:
a DC elimination unit for eliminating a DC component of the packet signal;
a correlator coupled to the DC elimination unit for calculating correlation between the packet signal and the access code according to the access code to generate a correction value; and
an first comparison unit coupled to the correlator for determining the comparison result according to a first threshold value and the correction value.

11. The wireless communication device of claim 9, wherein the estimation unit comprises:
a high pass filter for extracting a high frequency component of the packet signal; and
an energy estimation unit coupled to the high pass filter for estimating an energy of the packet signal to generate the estimation result.

12. The wireless communication device of claim 11, wherein the estimation unit comprises:
an operation unit coupled to the high pass filter for obtaining an amplitude of the packet signal;
a second comparison unit coupled to the operation unit for generating an energy comparison result according to a second threshold value and the amplitude of the packet signal;
an energy accumulation unit coupled to the second comparison unit for generating an accumulated value according to the energy comparison result; and
a third comparison unit coupled to the energy accumulation unit for generating the estimation result according to a third threshold value and the accumulated value.

13. The wireless communication device of claim 9, wherein the determination unit determines the packet signal belongs to the wireless communication device when the comparison result indicates conformity with the access code and the estimation result indicates substantially no energy beyond expected frequency bands.

14. The wireless communication device of claim 9, wherein the access code is corresponding to the wireless communication device.

15. The wireless communication device of claim 9, wherein the wireless communication signal is a Gaussian Frequency Shift Keying (GFSK) signal, and the packet signal is a Binary Phase Shift Keying (BPSK) signal.

16. The wireless communication device of claim 9, wherein the wireless communication device is a Bluetooth wireless communication device.
